(19) United States
(12) Patent Application Publication
(10) Pub. No.: US 2007/0040814 A1
(43) Pub. Date: Feb. 22, 2007

(54) Liquid crystal display device having improved touch screen

(75) Inventors: Joo-Hyung Lee, Gwacheon-si (KR); Sang-Jin Pak, Yongin-si (KR); Kee-Han Uh, Yongin-si (KR); Dong-Jin Jeong, Seoul (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/588,587

(22) Filed: Oct. 27, 2006

(30) Foreign Application Priority Data
Apr. 11, 2005 (KR) 10-2005-0105430

(51) Int. Cl. G09G 5/00

(52) U.S. Cl. 345/173

(57) ABSTRACT

A liquid crystal display having a touch screen includes a plurality of sensing data lines formed on a display panel, a plurality of variable capacitors connected to the sensing data lines and having capacitance that varies with a pressure, a plurality of reference capacitors connected to the sensing data lines, and a plurality of sensing signal output units each connected to the sensing data lines for generating output signals on the basis of sensing data signals that flow through the sensing data lines. The sensing signal output units change the amount of current based on the sensing data signals to reduce current corresponding to the output signals.

### CROSS-REFERENCE TO RELATED APPLICATION

This application claims priority to and the benefit of Korean Patent Application No. 10-2005-0105430 filed in the Korean Intellectual Property Office on Nov. 4, 2005, the entire contents of which are incorporated herein by reference.

### FIELD OF THE INVENTION

The present invention relates to a liquid crystal display having a touch screen.

### DESCRIPTION OF THE RELATED ART

A liquid crystal display (LCD), is representative of display devices that include two display panels respectively having a matrix of pixel electrodes and a common electrode with a liquid crystal layer having dielectric anisotropy interposed between the two panels. The pixel electrodes are connected to switching elements such as a thin film transistor (TFT). A data voltage is sequentially supplied to the pixel electrodes one row at a time. The common electrode is formed on the entire surface of one display panel and receives a common voltage. A pixel electrode, the common electrode, and the liquid crystal layer disposed therebetween form an equivalent circuit of a liquid crystal capacitor, and the liquid crystal capacitor with the switching element connected thereto is a basic unit for forming a pixel. The changing data voltages applied to the two electrodes generate an electric field that varies the transmittance of light passing through the liquid crystal layer so as to display images corresponding to the data voltages.

A touch screen panel is a device that allows a user to write text, draw pictures or execute an icon by contacting the screen with a finger touch pen or stylus. A liquid crystal display with a touch screen panel can determine whether or not a user's finger or a touch pen contacts on a screen, and can detect information about a contact location. However, the manufacturing cost of such a liquid crystal display increases due to the touch screen panel, and the yield of display devices is reduced by the additional manufacturing process involved in making the touch screen panel. Also, the touch screen panel reduces the luminance of the liquid crystal panel and increases the overall thickness of the liquid crystal display.

### SUMMARY OF THE INVENTION

In order to provide a touch screen liquid crystal display having improved luminance an exemplary embodiment of the present invention includes a plurality of sensing data lines formed on one of the display panels, a plurality of variable capacitors connected to the sensing data lines whose capacitance varies with pressure, a plurality of reference capacitors connected to the sensing data lines, and a plurality of sensing signal output units each connected to the sensing data lines for generating output signals on the basis of sensing data signals that flow through the sensing data lines.

A display device according to another exemplary embodiment of the present invention includes a plurality of sensing data lines formed among the pixels, a plurality of sensing units for changing the magnitude of the sensing data signals on the basis of capacitance that varies with an applied pressure, and a plurality of sensing signal output units for generating output signals. Each of the sensing signal output units includes a first switching element connected to the sensing data line for changing the amount of current that flows through the first switching element according to the variation in capacitance of the variable capacitors, a second switching element for receiving a second input signal and changing the operating state of the second switching element according to the second input signal, a third switching element connected to the sensing data line and the second switching element for changing an amount of current that is output from the third switching element according to the variation of the capacitance of the variable capacitors and the operating state of the second switching element, and a fourth switching element connected to the first switching element for changing the operating state of the fourth switching element to change the amount of current that flows through the fourth switching element according to the amount of current from the third switching element. The amount of current flowing through the first switching element and the amount of current flowing through the fourth switching element may be opposite to each other. The output signals is advantageously determined based on the amount of current flowing through the first switching element and the amount of current flowing through the fourth switching element.

When the capacitance of the variable capacitors increases, the amount of current flowing through the first switching element decreases in proportion to the sensing data signal based on the capacitance, and the amount of current flowing through the fourth switching element decreases in inverse proportion to the sensing data signal based on the capacitance.

### BRIEF DESCRIPTION OF THE DRAWING

Exemplary embodiments of the present invention will be described in detail with reference to the accompanying drawing, in which:

FIG. 1 is a block diagram of a liquid crystal display according to an exemplary embodiment of the present invention, in which the liquid crystal display is shown from the view of pixels.

FIG. 2 is an equivalent circuit diagram of one pixel of the liquid crystal display according to an exemplary embodiment of the present invention.

FIG. 3 is a block diagram of a liquid crystal display according to an exemplary embodiment of the present invention, in which the liquid crystal display is shown from the view of sensing units.

FIG. 4 is an equivalent circuit diagram of one sensing unit of the liquid crystal display according to an exemplary embodiment of the present invention.

FIG. 5 is a schematic diagram of the liquid crystal display according to an exemplary embodiment of the present invention.

FIG. 6A is an equivalent circuit illustrating a plurality of sensing units connected to a sensing data line in a liquid crystal display according to an exemplary embodiment of the present invention.

FIG. 6B shows a simplified equivalent circuit of FIG. 6A.

FIG. 7 is a timing diagram for describing a sensing operation in a liquid crystal display according to an exemplary embodiment of the present invention.

FIG. 8A is an equivalent circuit diagram illustrating a plurality of sensing units connected to one sensing data line according to another exemplary embodiment of the present invention.

FIG. 8B shows a simplified equivalent circuit of FIG. 6A.

FIG. 9 is a timing diagram illustrating the sensing operation of a liquid crystal display according to another exemplary embodiment of the present invention.

### DETAILED DESCRIPTION OF THE EMBODIMENTS

The present invention will now be described more fully hereinafter with reference to the accompanying drawings, in which preferred embodiments of the invention are shown.

In the drawings, the thickness of layers, films, panels, regions, etc., are exaggerated for clarity. Like reference numerals designate like elements throughout the specification. It will be understood that when an element such as a layer, film, region or substrate is referred to as being “on” another element, it can be directly on the other element or intervening elements may also be present. In contrast, when an element is referred to as being “directly on” another element, there are no intervening elements present.

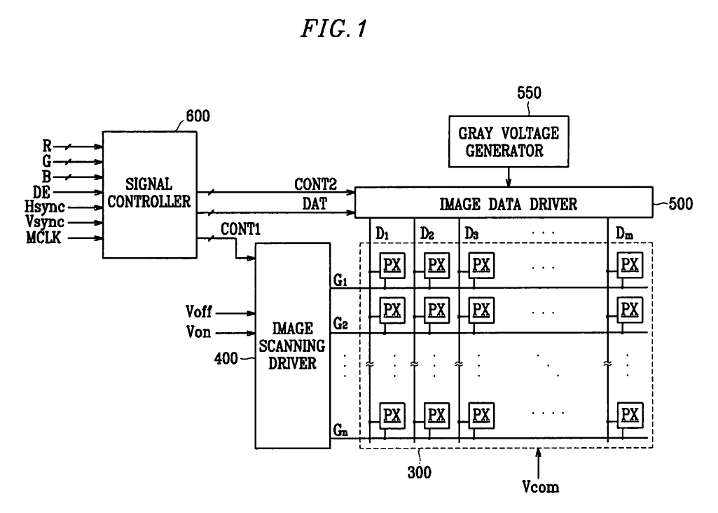

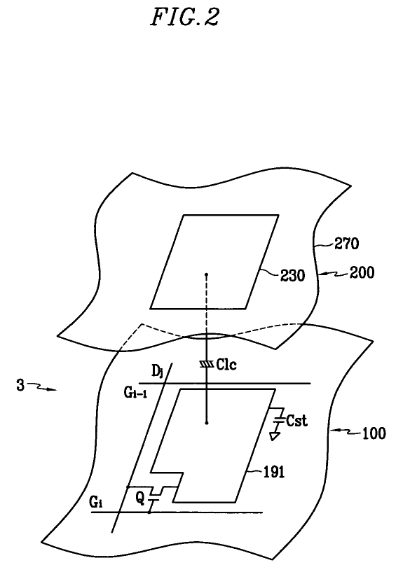

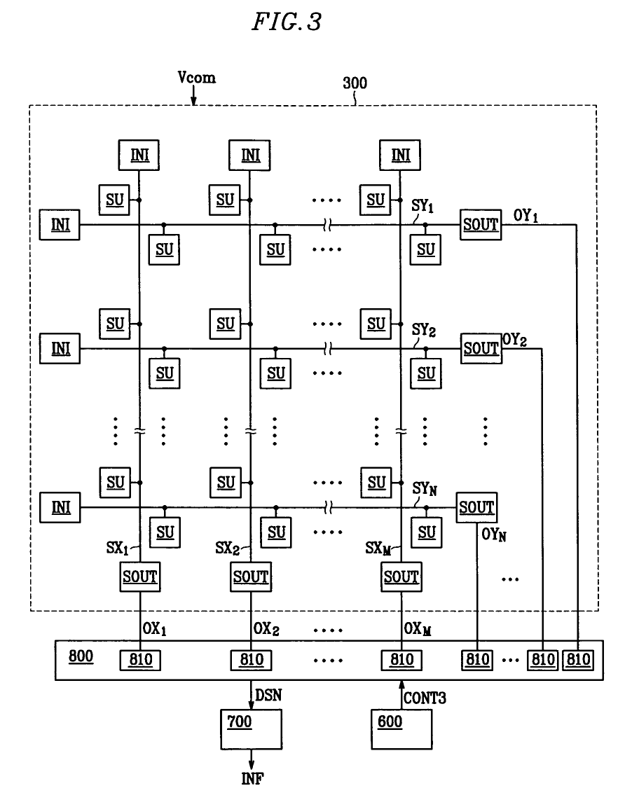

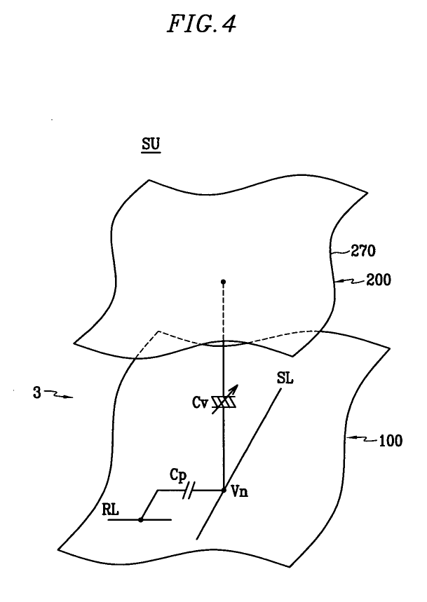

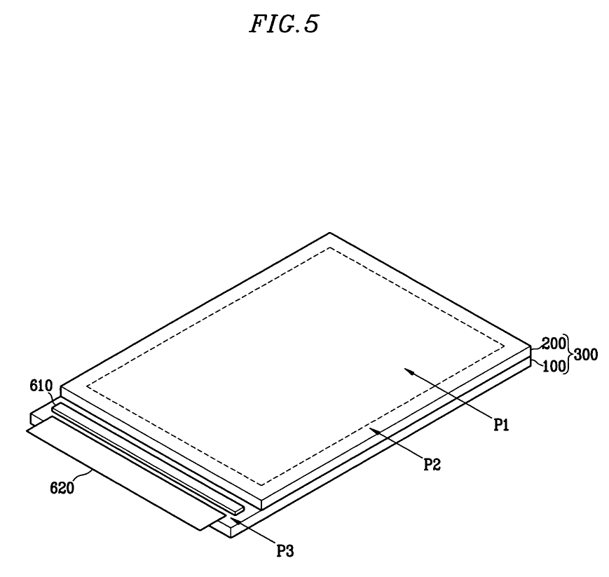

A liquid crystal display according to an exemplary embodiment of the present invention will now be described in detail with reference to FIG. 1 to FIG. 5. FIG. 1 is a block diagram of a liquid crystal display according to an exemplary embodiment of the present invention, in which the liquid crystal display is shown from the view of pixels. FIG. 2 is an equivalent circuit diagram of one pixel of the liquid crystal display according to an exemplary embodiment of the present invention. FIG. 3 is a block diagram of a liquid crystal display according to an exemplary embodiment of the present invention, in which the liquid crystal display is shown from the view of sensing units. FIG. 4 is an equivalent circuit diagram of one sensing unit of the liquid crystal display according to an exemplary embodiment of the present invention. FIG. 5 is a schematic diagram of the liquid crystal display according to an exemplary embodiment of the present invention.

Referring to FIG. 1 and FIG. 3, the liquid crystal display according to an exemplary embodiment of the present invention includes a liquid crystal panel assembly 300, an image scanning driver 400, an image data driver 500, and a sensing signal processing unit 800 connected to the liquid crystal panel assembly 300, a gray voltage generator 550 connected to image data driver 500, a contact determination unit 700 connected to sensing signal processing unit 800, and a signal controller 600 for controlling the liquid crystal panel assembly 300, image scanning driver 400, the image driver 500, the gray voltage generator 550, contact determination unit 700, and sensing signal processing unit 800.

Referring to FIG. 1 to FIG. 4B, the liquid crystal panel assembly 300 includes a plurality of display signal lines G₁-Gₙ and D₁-Dₘ, a plurality of pixels PX connected to the display signal lines and arranged basically in a matrix, a plurality of sensing signal lines SY₁-SY_{N}, SX₁-SX_{M}, and RL, a plurality of sensing units SU connected to the sensing signal lines and arranged basically in a matrix, a plurality of initial signal input units INI connected to one end of the sensing signal lines SY₁-SY_{N} and SX₁-SX_{M}, a plurality of sensing signal output units SOUT connected to the other end of the sensing signal lines SY₁-SY_{N} and SX₁-SX_{M}, and a plurality of output data lines OY₁-OY_{N} and OX₁-OX_{M} connected to the sensing signal output units SOUT.

Referring to FIG. 2 and FIG. 5, the liquid crystal panel assembly 300 includes a thin film transistor array panel 100 and a common electrode panel 200 arranged to face each other, a liquid crystal layer 3 interposed between the thin film transistor array panel 100 and the common electrode panel 200, and a spacer (not shown) that maintains a gap between the two panels 100 and 200 and has a capability to be compressed and transformed by a predetermined degree.

The display signal lines G₁-Gₙ and D₁-Dₘ include a plurality of image scanning lines G₁-Gₙ for transferring image scanning signals, and a plurality of image data lines D₁-Dₘ for transferring image data voltages.

The sensing signal lines SY₁-SY_{N}, SX₁-SX_{M}, and RL includes a plurality of horizontal sensing data lines SY₁-SY_{N} and a plurality of vertical sensing data lines SX₁-SX_{M} for transferring sensing data signals, and a plurality of reference voltage lines RL for transferring reference voltages. The reference voltage lines RL can be omitted if necessary.

The image scanning lines G₁-Gₙ and the horizontal sensing data lines SY₁-SY_{N} extend basically in a row direction to run almost parallel to each other. The image data lines D₁-Dₘ and the vertical sensing data lines SX₁-SX_{M} extend basically in a column direction to run almost parallel to each other. The reference voltage lines RL extend in a row or column direction.

Each pixel PX includes a switching element Q connected to the display signal lines G₁-G_{N} and D₁-Dₘ, and a liquid crystal capacitor Clc and a storage capacitor Cst connected to the switching element Q. The storage capacitor Cst can be omitted if necessary.

The switching element Q is a three terminal element such as a thin film transistor provided on the thin film transistor array panel 100 and has a control terminal connected to the image scanning lines G₁-Gₙ, an input terminal connected to the image data lines D₁-Dₘ, and an output terminal connected to the liquid crystal capacitor Clc and the storage capacitor Cst. The thin film transistor includes amorphous silicon or polycrystalline silicon.

The liquid crystal capacitor Clc uses the pixel electrode 191 of the thin film transistor array panel 100 and the common electrode 270 of the common electrode panel 200 as two terminals, and a liquid crystal layer 3 between the two electrode 191 and 270 functions as a dielectric material. The pixel electrode 191 is connected to the switching element Q, and the common electrode 270 is formed on the entire surface of the common electrode panel 200 to receive a common voltage Vcom. Unlike in FIG. 2, the common electrode 270 may be provided on the thin film transistor array panel 100, and at least one of the two electrodes 191 and 270 may be linear or rod-shaped.

The storage capacitor Cst that supplements the liquid crystal capacitor Clc is made by overlapping another signal line (not shown) provided on the thin film transistor array panel 100 and the pixel electrode 191 with an insulator interposed therebetween, and a predetermined voltage such as the common voltage Vcom is applied to the other signal line. However, the storage capacitor Cst may be made by overlapping the pixel electrode 191 and a previous image scanning line with the insulator interposed therebetween.

In order to implement color display, each pixel PX uniquely displays one of primary colors (spatial division) or alternately displays the primary colors in accordance with time (temporal division) so that a desired color is recognized by the spatial and temporal sum of the primary colors. The primary colors may be red, green, and blue. FIG. 2 illustrates an example of the spatial division in which each pixel PX has a color filter 230 that represents one of the primary colors in the region of the common electrode panel 200 corresponding to the pixel electrode 191. Unlike in FIG. 2, the color filter 230 may be formed on or under the pixel electrode 191 of the thin film transistor array panel 100.

At least one polarizer (not shown) is attached on the outside surface of the liquid crystal panel assembly 300 to polarize light.

As shown in FIG. 4, the sensing unit includes a variable capacitor Cv connected to a horizontal or vertical sensing data line SL (hereinafter, called a sensing data line) and a reference capacitor Cp connected between the sensing data line SL and the reference voltage line RL.

The reference capacitor Cp is made by overlapping the reference voltage line RL and the sensing data line SL of the thin film transistor array panel 100 with an insulator (not shown) interposed therebetween.

The variable capacitor Cv uses the sensing data line SL of the thin film transistor array panel 100 and the common electrode 270 of the common electrode panel 200 as two terminals, and the liquid crystal layer 3 between the two terminals functions as a dielectric material. The capacitance of the variable capacitor Cv varies with the stimulus from the outside such as a user's touch applied to the liquid crystal panel assembly 300. When pressure is applied to the common electrode panel 200, the spacer is compressed and transformed to change the distance between the two terminals and to thus change the capacitance of the variable capacitor Cv.

When the capacitance of the variable capacitor Cv changes, the value of a contact voltage Vn between the reference capacitor Cp and the variable capacitor Cv also changes depending on the capacitance. The contact voltage Vn is a sensing data signal and flows through the sensing data line SL and makes possible the determination whether or not contact has been made. Since the reference capacitor Cp has a fixed capacitance and the reference voltage applied to the reference capacitor Cp has a predetermined voltage value, the contact voltage Vn varies within a predetermined range. Therefore, the sensing data signal can always have a voltage level within the constant range, and thus the occurrence of the contact and the contact location can be easily determined.

The sensing unit SU is disposed between two adjacent pixels. The density of a pair of sensing units SU may be, for example, about ¼ of the dot density. For example, one dot includes three pixels that are arranged in parallel and that display three primary colors such as red, green, and blue, and forms a fundamental unit indicating the resolution of a liquid crystal display. However, one dot may also be made of four or more pixels, and in this case, each pixel PX may display one of three primary colors and white.

In the example in which the density of a pair of sensing units SU is about ¼ of the dot density, the horizontal and vertical resolution of the pair of sensing units SU may be about ½ of the horizontal and vertical resolution of the liquid crystal display, respectively. In this case, there may be rows and columns of pixels with no sensing unit.

If the density of sensing units SU and the dot density are adjusted to such degrees, the liquid crystal display can be employed even to a high-accuracy application field such as character recognition. The resolution of sensing units may be higher or lower as necessary.

As described above, using the sensing units SU according to an exemplary embodiment of the present invention, the space occupied by the sensing units and the sensing data lines SL is relatively small, and thus the reduction of the opening ratio of pixels can be minimized.

The plurality of reset signal input units INI have the same structure, and the plurality of sensing signal output units SOUT also have the same structure. The structures and operations of the initial signal input units and sensing signal out units INI and SOUT will be described in detail later.

The output data lines OY₁-OY_{N} and OX₁-OX_{M} include the plurality of horizontal and vertical output data lines OY₁-OY_{N} and OX₁-OX_{M} connected to the horizontal and vertical sensing data lines SY₁-SY_{N} and SX₁-SX_{M} through the corresponding sensing signal output units SOUT, respectively.

The output data lines OY₁-OY_{N} and OX₁-OX_{M} are connected to sensing signal processing unit 800 to transmit output signals from the sensing signal output units SOUT to sensing signal processing unit 800. The horizontal and vertical output data lines OY₁-OY_{N} and OX₁-OX_{M} extend basically in a column direction to run almost parallel to each other.

Referring to FIG. 1 and FIG. 3 again, the gray voltage generator 550 generates two pairs of gray voltage sets (or reference gray voltage sets) related to the transmittance of pixels. One of the two pairs of gray voltage sets has a positive value for the common voltage Vcom, and the other has a negative value for the common voltage Vcom.

Image scanning driver 400 applies image scanning signals to the image scanning lines G₁-Gₙ, under control of a gate-on voltage Von and a gate-off voltage Voff that turn the switching element Q on and off.

Image data driver 500 is connected to the image data lines D₁-Dₘ of the liquid crystal panel assembly 300 to select a gray voltage from the gray voltage generator 550 and then to transmit the gray voltage to the image data lines D₁-Dₘ as an image data signal. If the gray voltage generator 550 provides only the predetermined number of reference gray voltages rather than all gray voltages, image data driver 500 divides the reference gray voltage to generate gray voltages for all gray levels and selects the image data signals from among the gray voltages.

Sensing signal processing unit 800 includes a plurality of amplifying units 810 connected to the output data lines OY₁-OY_{N} and OX₁-OX_{M} of the liquid crystal panel assembly 300, and performs signal processing by amplifying output signals from the amplifying units 810 to generate analog sensing signals Vo and converting the analog sensing signals V0 into digital signals through an analog-to-digital converter (not shown) to generate digital sensing signals DSN.

Contact determination unit 700 receives the digital sensing signals DSN from sensing signal processing unit 800, performs predetermined signal processing, determines whether or not contact is made, detects a contact location, and outputs the contact information INF to an external device. Contact determination unit 700 controls signals applied to the sensing units by monitoring the operation state of the sensing units SU on the basis of the digital sensing signals DSN.

Signal controller 600 controls the operations of image scanning driver 400, image data driver 500, the gray voltage generator 550, and sensing signal processing unit 800.

Each of the driving devices 400, 500, 550, 600, 700, and 800 may be directly mounted on the liquid crystal panel assembly 300 in the form of at least one IC chip, may be mounted on a flexible printed circuit film (not shown) to be attached to the liquid crystal panel assembly 300 in the form of a tape carrier package TCP, or may be mounted on an additional printed circuit board PCB (not shown). Unlike the above, the driving devices 400, 500, 550, 600, 700, and 800 may be integrated with liquid crystal panel assembly 300 together with the signal lines G₁-Gₙ, D₁-Dₘ, SY₁-SY_{N}, SX₁-SX_{M}, OY₁-OY_{N}, OX₁-OX_{M}, and RL, and the thin film transistor Q.

Referring to FIG. 5, the liquid crystal panel assembly 300 is divided into a display region P1, an edge region P2, and an exposure region P3.

Most of the pixels PX, the sensing units SU, and the signal lines G₁-Gₙ, D₁-Dₘ, SY₁-SY_{N}, SX₁-SX_{M}, OY₁-OY_{N}, OX₁-OX_{M}, and RL are placed at the display region P1. The common electrode panel 200 includes a light blocking member (not shown) covering most of the edge region P2, such as a black matrix, to block light from the outside. Since the common electrode panel 200 is smaller in size than the thin film transistor array panel 100, a portion of the thin film transistor array panel 100 is exposed to form the exposure region P3. A single chip 610 is mounted on the exposure region P3, and a flexible printed circuit FPC board 620 is attached to the exposure region P3.

The single chip 610 includes the driving devices for driving the liquid crystal display, that is, image scanning driver 400, image data driver 500, the gray voltage generator 550, signal controller 600, contact determination unit 700, and sensing signal processing unit 800.

Integrating the driving devices 400, 500, 550, 600, 700, and 800 into the single chip 610 can decrease the mounting area and power consumption. Also, at least one of the driving devices 400, 500, 550, 600, 700, and 800 or at least one circuit element that forms the driving devices 400, 500, 550, 600, 700, and 800 may be provided outside the single chip 610, if necessary.

The image signal lines G₁-Gₙ and D₁-Dₘ and the sensing data lines SY₁-SY_{N} and SX₁-SX_{M} extend up to the exposure region P3 to be connected to the corresponding driving devices 400, 500, and 800.

The FPC board 620 receives signals from an external device and transmits the received signals to the single chip 610 or the liquid crystal panel assembly 300. In order to facilitate the connection with the external device, the end of the FPC board 620 is usually formed with a connector (not shown).

The display and sensing operations of the liquid crystal display will now be described in detail.

Signal controller 600 receives input image signals R, G, and B and input control signals for controlling the display of the input image signals R, G, and B from external devices (not shown). The input image signals R, G, and B contain the luminance information of each pixel PX, and the luminance has a predetermined number of gray levels, for example, 1024 (=2¹⁰), 256 (=2⁸), or 64 (=2⁶) gray levels. The input control signals may be a vertical synchronizing signal Vsync, a horizontal synchronizing signal Hsync, a main clock signal MCLK, and a data enable signal DE.

Signal controller 600 processes the input image signals R, G, and B to be suitable for the operation state of the liquid crystal panel assembly 300 and image data driver 500 on the basis of the input image signals R, G, and B and the input control signals, generates an image scanning control signal CONT1, an image data control signal CONT2, and a sensing data control signal CONT3, outputs the image scanning control signal CONT1 to image scanning driver 400, outputs the image data control signal CONT2 and the processed image signals DAT to image data driver 500, and outputs the sensing data control signal CONT3 to sensing signal processing unit 800.

The image scanning control signal CONT1 includes a scanning start signal STV for instructing the start of a scanning operation and at least one clock signal for controlling the output of the gate-on voltage Von. The image scanning control signal CONT1 may further include an output enable signal OE for limiting the duration of the gate-on voltage Von.

The image data control signal CONT2 includes a horizontal synchronizing start signal STH for indicating the start of transmission of image signals DAT in one pixel row, a loading signal LOAD for instructing to load the image data signals to the image data lines D₁-Dₘ, and a data clock signal HCLK. The image data control signal CONT2 may further include an inversion signal RVS for inverting the voltage polarity of the image data signal to the common voltage Vcom (hereinafter, the voltage polarity of the image data signal to the common voltage Vcom will be referred to as the polarity of the image data signal).

In accordance with the image data control signal CONT2 from signal controller 600, image data driver 500 receives digital image signals DAT for pixels in one pixel row and selects gray voltages corresponding to the respective digital image signals DAT to convert the digital image signals DAT into analog image data signals and to apply the analog image data signals to the corresponding image data lines D₁-Dₘ.

Image scanning driver 400 applies the gate-on voltage Von to the image scanning lines G₁-Gₙ in accordance with the image scanning control signal CONT1 from signal controller 600 to turn on the switching element Q connected to the image scanning lines G₁-Gₙ. Then, the image data signals applied to the image data lines D₁-Dₘ are applied to the corresponding pixels PX through the turned on switching element Q.

The difference between the voltage of the image data signal applied to the pixel PX and the common voltage Vcom is the charging voltage of the liquid crystal capacitor Clc, that is, the pixel voltage. The arrangement of the liquid crystal molecules varies with the magnitude of the pixel voltage so that the polarization of light that passes through the liquid crystal layer 3 changes. The change in the polarization causes a change in transmittance of light by polarizers (not shown) attached to the liquid crystal panel assembly 300, and thus desired images can be displayed.

By repeating the above operations in units of one horizontal period 1H (which is the same as one period of the horizontal synchronizing signal Hsync and the data enable signal DE), the gate-on voltage Von is sequentially applied to all of the image scanning lines G₁-Gₙ to apply the image data signals to all of the pixels so as to display one frame of images.

The state of the inversion signal RVS applied to the data driver 500 is controlled so that when one frame ends the next frame starts, and so that the polarities of the image data signals applied to the respective pixels are opposite to the polarities in the previous frame (“frame inversion”). Even in one frame, the polarity of the image data signal that flows through one image data line may change (for example row inversion and dot inversion), or the polarities of the image data signals that are applied to one pixel column may be different from each other (for example column inversion and dot inversion) in accordance with the characteristic of the inversion signal RVS.

Sensing signal processing unit 800 reads the sensing data signals that are applied through the output data lines OY₁-OY_{N} and OX₁-OX_{M} in porch periods between frames once every frame in accordance with the sensing data control signal CONT3. Since the sensing data signals are less affected by driving signals from image scanning driver 400 and image data driver 500 in the porch periods, the reliability of the sensing data signals improves. It is not necessary to perform the reading operation at every frame, and it is possible to perform it once for a plurality of frames if necessary. Also, it is possible to perform the reading operation more than twice in one porch period and to perform it at least once in a frame.

Sensing signal processing unit 800 performs signal processing operations such as the amplification of the read analog sensing data signals by the respective amplifying units 810, converts the processed analog sensing data signals into digital sensing signals DSN, and outputs the converted digital sensing signals DSN to contact determination unit 700. The operation of the amplifying units 810 in sensing signal processing unit 800 will be described in detail later.

Contact determination unit 700 receives the digital sensing signals DSN and performs appropriate processing operations for the received digital sensing signals DSN to determine whether or not a contact is made and to detect the contact location, and transmits the contact information to an external device. The external device then transmits image signals R, G, and B to the liquid crystal display.

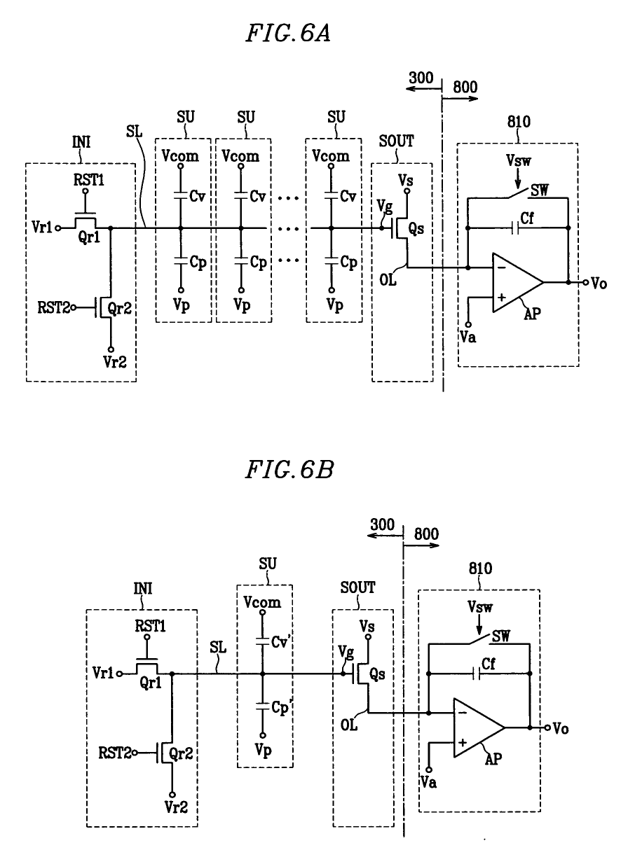

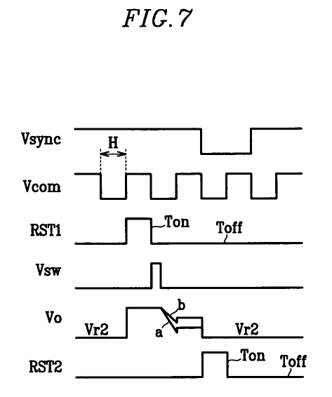

The structures and operations of the reset signal input unit INI, the sensing signal output unit SOUT, and the amplifier 810 according to an exemplary embodiment of the present invention will now be described with reference to FIG. 6A to FIG. 7.

FIG. 6A is an equivalent circuit illustrating a plurality of sensing units connected to a sensing data line in a liquid crystal display according to an exemplary embodiment of the present invention, and FIG. 6B shows a simplified equivalent circuit of FIG. 6A. FIG. 7 is a timing diagram for describing a sensing operation in a liquid crystal display according to an exemplary embodiment of the present invention.

FIG. 6A and FIG. 6B show the relationship among the plurality of sensing data lines SL (SY₁-SY_{N} and SX₁-SX_{M} in FIG. 3), the plurality of sensing units SU connected to each data line SL, the reset signal input unit INI connected to one end of each data line SL, and the plurality of sensing signal output units SOUT connected between the other end of each sensing data line SL and an output data line OL (OY₁-OY_{N}, and OX₁-OX_{M} in FIG. 3), as described above with reference to FIG. 3. Also, a sensing signal processing unit 800 includes a plurality of amplifying units 810 each connected to each output data line OL as described with respect to FIG. 3.

That is, a plurality of sensing units SU each having a variable capacitor Cv and a reference capacitor Cp are connected at a single sensing data line SL. One end of the sensing data line SL is connected to a reset signal input unit INI, and the other end of the sensing data line SL is connected to a sensing signal output unit SOUT. The variable capacitor Cv is connected to a common voltage Vcom, and the reference capacitor Cp is connected to a reference voltage Vp.

As described above, each variable capacitor Cv is made of a sensing data line SL and a common electrode 270 as two terminals, and a variable capacitor Cv′ shown in FIG. 6B represents the plurality of variable capacitors Cv. Substantially, the capacitance of the variable capacitor Cv′ is uniformly distributed along the single sensing data line SL. As shown in FIG. 6B, a single reference capacitor Cp′ represents a plurality of reference capacitors Cp corresponding to the variable capacitor Cv′.

Each of the reset signal input units INI includes a first and a second reset transistor Qr1 and Qr2. The first and second reset transistors Qr1 and Qr2 are three terminal elements such as a thin film transistor that includes a control terminal connected to the first and second reset control signals RST1 and RST2, an input terminal connected to the first and second reset voltages Vr1 and Vr2, and an output terminal connected to a sensing data line SL.

The first and second reset transistors Qr1 and Qr2 are disposed at the edge region P2 of the liquid crystal panel assembly 300 where a pixel is not disposed, and supply the first and second reset voltages Vr1 and Vr2 to the sensing data line SL according to the first and second reset control signals RST1 and RST2.

The sensing signal output unit SOUT includes an output transistor Qs. The output transistor Qs is also a three terminal element such as a thin film transistor, which includes a control terminal connected to the sensing data line SL, an input terminal connected to the input voltage Vs, and an output terminal connected to the output data line OL. The output transistor Qs is also disposed at an edge region P2 of the liquid crystal panel assembly 300, and generates an output signal based on a sensing data signal that flows along the sensing data line SL. The output signal may be an output current. Differently, an output transistor Qs may create a voltage as an output signal.

Each of amplifying units 810 includes an amplifier AP, a capacitor Cf, and a switch SW. The amplifier AP includes an inversion terminal (−), a non-inversion terminal (+), and an output terminal. The inversion terminal (−) is connected to the output data line OL. The capacitor Cf and the switch SW are connected between the inversion terminal (−) and the output terminal, and the non-inversion terminal (+) is connected to a reference voltage (Va). The amplifier AP and the capacitor Cf form a current integrator that generates a sensing signal Vo by integrating the output current from the output transistor Qs for a predetermined time.

Referring to FIG. 7, the liquid crystal display according to the present exemplary embodiment performs a sensing operation in a porch period between frames. It is preferable that the liquid crystal display device according to the present embodiment may perform a sensing operation in a front porch period that precedes the synchronization signal Vsync.

The common voltage Vcom has a high level and a low level, and swings between the high level and the low level at every 1H.

Each of the first and second reset control signals RST1 and RST2 has a turn-on voltage Ton and a turn-off voltage Toff for turning on/off the first and second reset transistors Qr1 and Qr2. The turn-on voltage Ton may be about 7 to 15V, and the turn-off voltage Toff may be about 0 to −15V. Also, the turn-on voltage Ton may use a gate-on voltage Von, and the turn-off voltage Toff may use a gate-off voltage Voff. The turn-on voltage (Ton) of the first reset control signal RST1 is supplied when the common voltage Vcom is a high level.

Sensing data line SL is initialized when a turn-on voltage Ton is supplied to first reset transistor Qr1 which turns on and applies first reset voltage Vr1 to sensing data line SL.

If a reference voltage Va is supplied to amplifier 810 when operation begins, the magnitude of the output voltage Vo of the amplifier AP becomes identical to the reference voltage Va because the capacitor Cf of the amplifier 810 is charged with the reference voltage Va.

When the initial operation of the sensing data line SL ends, an operation for reading the sensing signal Vo is performed.

Therefore, when the first reset control signal RST1 is turned off after the initial operation ends, the sensing data line SL becomes a floating state, and a voltage supplied to the control terminal of the output transistor Qs varies based on variation of the capacitance of the variable capacitor Cv′ and the common voltage Vcom according to the state of the contacts determined by the sensing unit. The current of the sensing data signal that flows through the output transistor Qs varies according to the voltage variation.

This will now be described in more detail. The voltage Vg supplied to the control terminal of the output transistor Qs is calculated by [Equation 1].

$$Vg = Vr 1 - \frac{{Cv}^{′}}{{Cp}^{′} + {Cv}^{′}} ( VcomH - VcomL ) \qquad [ Equation 1 ]$$

In Equation 1, VcomH denotes a value of high level common voltage, VcomL denotes a value of low level common voltage, Cp′ denotes the capacitance of reference capacitor, and Cv′ denotes the capacitance of a variable capacitor.

If the sensing unit SU is contacted by a user, the distance between the display panels 100 and 200 becomes closer and the capacitance of the variable capacitor Cv′ increases. As shown in [Equation 1], if the capacitance of the variable capacitor Cv′ increases, the voltage Vg supplied to the control terminal of the output transistor Qs is reduced, and the amount of current flowing to the amplifying unit 810 is also reduced in proportion to the magnitude of voltage Vg. As a result, when contact is made by a user, the amount of current supplied to the amplifying unit 810 is reduced compared to that supplied when the contact is not made to the sensing unit Su.

The voltage on capacitor Cf is discharged by supplying a high level switching signal Vsw to switch SW before the sensing signal Vo output from amplifying unit 810 is read. After a predetermined time has passed, sensing signal processing unit 800 reads the sensing signal Vo. It is preferable to set the time for reading the sensing signal Vo within a 1H time after the first reset control signal RST1 becomes the gate-off voltage Voff. That is, it is preferable to read the sensing signal Vo before the common voltage Vcom becomes high again. This is because the sensing signal Vo also changes as the level of the common voltage Vcom changes.

As described above, the amount of current applied to the amplifying unit 810 varies according to whether the contact is made to the sensing unit SU. When no contact is made to the sensing unit as shown in (a) of FIG. 7 the sensing signal Vo is output. However, when contact is made to the sensing unit the amount of current applied to the amplifying unit 810 is reduced and the sensing signal Vo increases as shown in (b) of FIG. 7.

Since the sensing data signal varies with the first reset voltage Vr1 as a reference, the sensing data signal can have the constant range of voltage level. Accordingly, the occurrence of the contact and the contact location can be easily determined.

After sensing signal processing unit 800 reads the sensing signal Vo, the second reset control signal RST2 becomes the turn-on voltage Ton so as to turn on the second reset transistor Qr2. Then, the second reset voltage Vr2 is supplied to the sensing data line SL. Since the second reset voltage Vr2 is a ground voltage, the sensing data line SL is reset to the ground voltage.

The second reset voltage Vr2 is sustained until a next first reset voltage Vr2 is supplied to the sensing data line SL. Accordingly, the output transistor Qs sustains the turn off state until the next first reset voltage Vr2 is supplied to the sensing data line SL so as to reduce power consumption wasted by unnecessary operations.

Also, the second reset voltage Vr2 and the common voltage Vcom form an electric field at a liquid crystal layer between the sensing data line SL and the common electrode 270, and the tilt directions of liquid crystal molecules therebetween are determined according to the formed electric field. The variation amount of the sensing data signal varies according to the tilt direction of the liquid crystal molecules. Herein, the sensitivity of the sensing unit can be improved by setting the second reset voltage Vr2 to an appropriate value to increase the variation amount of the sensing data signal.

The turn-on voltage Ton of the first reset control signal RST1 may be applied when the common voltage Vcom is in a low level. Herein, the sensing signal Vo is read before the common voltage Vcom transits to the low level after the common voltage Vcom had transited to the high level. Also, the first reset control signal RST1 may be synchronized to an image scan signal supplied to a last image scanning line Gn.

The second reset control signal RST2 may become a turn-on voltage in a next 1H period right after reading a sensing signal Vo, or may become a turn-voltage Ton in the 1H period after the next 1H period.

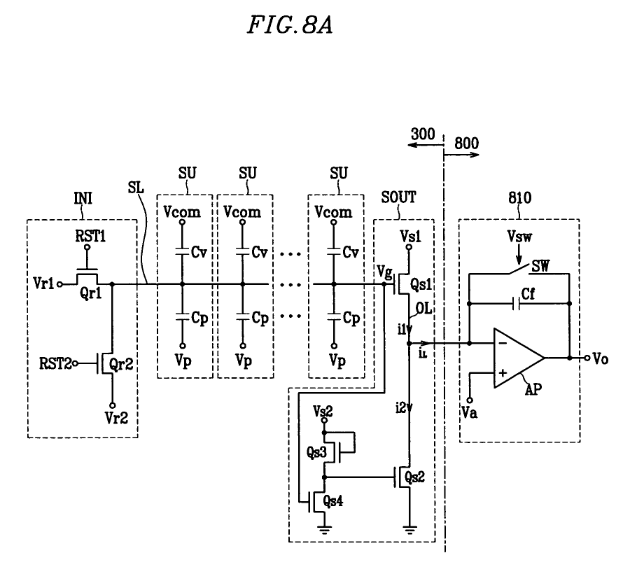

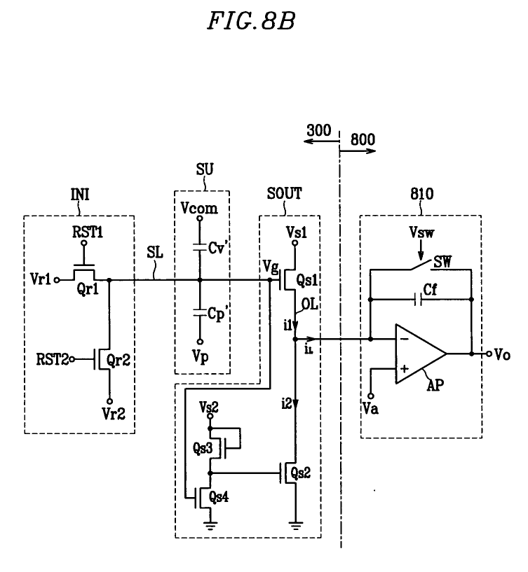

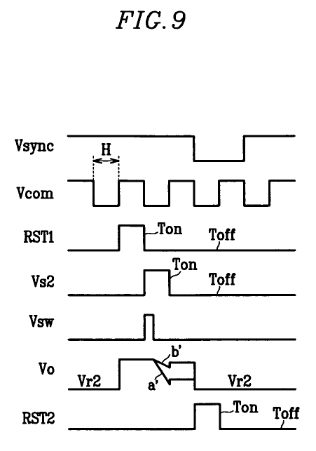

Hereinafter, the structures and the operations of a reset signal input unit INI, a sensing signal output unit SOUT1, and an amplifying unit 810 according to another exemplary embodiment of the present invention will be described with reference to FIG. 8A to FIG. 9.

FIG. 8A is an equivalent circuit diagram illustrating a plurality of sensing units connected to one sensing data line according to another exemplary embodiment of the present invention, FIG. 8B shows a simplified equivalent circuit of FIG. 6A, and FIG. 9 is a timing diagram illustrating the sensing operation of a liquid crystal display according to another exemplary embodiment of the present invention.

As shown in FIG. 8A and FIG. 8B, excepting the structure of the sensing signal output unit SOUT1, a reset signal input unit INI and an amplifying unit 810 are identical to those shown in FIG. 6A and FIG. 6B. Therefore, detailed descriptions thereof are omitted.

As shown in FIG. 8A and FIG. 8B, the sensing signal output unit SOUT1 includes first to fourth output transistors Qs1 to Qs4. The first to fourth output transistors Qs1 to Qs4 are three terminal elements such as thin film transistors. Each of the first to fourth transistors Qs1 to Qs4 includes a control terminal, an input terminal, and an output terminal.

The first output transistor Qs1 includes an input terminal for receiving a first input voltage Vs1, a control terminal connected to a sensing data line SL, and an output terminal connected to the non-inversion terminal (−) of the amplifier AP of the amplifying unit 810.

The second output transistor Qs2 includes an input terminal connected to the output terminal of the first output transistor Qs1, and an output terminal for receiving a ground voltage.

The third output transistor Qs3 includes an input terminal and a control terminal for receiving the second input voltage Vs2, and an output terminal connected to the control terminal of the second output transistor Qs2.

The fourth output transistor Qs4 includes an input terminal connected to the output terminal of the third transistor Qs3, a control terminal connected to the sensing data line SL, and an output terminal for receiving a ground voltage.

The first to fourth output transistors Qs1 to Qs4 are disposed at the edge region P2 of the liquid crystal display assembly 300 where a pixel PX is not disposed.

The operations of the reset signal input unit INI, the sensing signal output unit SOUT1, and the amplifying unit 810 according to another exemplary embodiment of the present invention will now be described.

The second input voltage Vs2 has a turn-on voltage Ton and a turn-off voltage Toff to turn on the third output transistor Qs3 as with the first and second reset control signals RST1 and RST2 described with reference to FIG. 6A to FIG. 7, and has an inverse form of the first reset control signal RST1. The turn-on voltage Ton of the second input voltage Vs2 is about 3 to 15V, and the turn-off voltage Toff of the second input voltage Vs2 is about 0V.

If the turn-on voltage Ton is supplied to the first reset transistor Qr1, the first reset transistor Qr1 is turned on. The turned-on first reset transistor Qr1 supplies the first reset voltage Vr1 supplied to the input terminal thereof to the sensing data line SL so as to initialize the sensing data line SL with the first reset voltage Vr1. At this moment, since the second input voltage Vs2 sustains the turn-off voltage Toff, the third output transistor Qs3 sustains the turn-off state. However, the first reset voltage Vr1 is supplied to the control terminal of the fourth output transistor Qs4 by the turn-on operation of the first reset transistor Qr1. As a result, the fourth output transistor Qs4 is turned on. Therefore, the second transistor Qs2 sustains the turn-off state, and the current does not flow through the second transistor Qs2.

If the first reset control signal RST1 becomes the turn-off voltage Toff after initialization, the sensing data line SL becomes a floating state. Accordingly, the voltage Vg supplied to the control terminal of the first output transistor Qs1 varies based on the capacitance variation of the variable capacitor Cv′ and the variation of the common voltage Vcom according to the occurrence of the contact determined at the sensing unit SU. When the first reset control signal RST1 becomes a turn-off voltage, the third output transistor Qs3 is turned on because the second input voltage Vs2 becomes the turn-on voltage Ton. At this moment, the fourth output transistor Qs4 performs different operations according to the voltage Vg supplied to the control terminal as with the first output transistor Qs1.

Accordingly, the amount of current supplied to the amplifying unit 810 is determined not only according to the operations of the first output transistor Qs1, but also according to the operations of the second to fourth output transistors Qs2 to Qs4, which vary according to whether a contact is made at the sensing unit SU.

That is, when the third output transistor Qs3 is turned on, the third output transistor Qs3 supplies the second input voltage Vs to the control terminal of the second output transistor Qs2. Accordingly, the voltage supplied to the control terminal of the second output transistor Qs2 increases. The increased voltage increases the amount of current flowing through the second output transistor Qs2, and the amount of current flowing to the amplifier AP of the amplifying unit 810 is reduced by as much as the increased amount of the current passing through the second output transistor Qs2.

This will now be described in more detail.

At first, if a contact is not detected at the sensing unit SU, a voltage Vg determined by [Equation1] is supplied to the control terminals of the first to fourth output transistors Qs1 to Qs4, and a first current i1 that is determined in proportion to the voltage Vg passes through the first output transistor Qs1. Also, a voltage that is determined based on a voltage Vg supplied to the control terminal of the fourth transistor Qs4 is supplied to the control terminal of the second output transistor Qs2, and the corresponding amount of the second current i2 passes through the second output transistor Qs2. The amount of current supplied to the amplifying unit 810 is determined by i1-i2.

If a contact is made at the sensing unit SU in this state, a voltage Vg supplied to the control terminal of the first output transistor Qs1 is reduced. Accordingly, the amount of current i1 passing through the first output transistor Qs1 is reduced. Since the voltage Vg is also supplied to the control terminal of the fourth output transistor Qs4, the amount of current passing through the fourth output transistor Qs4 is also reduced. Accordingly, a voltage supplied to the control terminal of the second output transistor Qs2 increases. Therefore, the amount of current i2 passing through the second output transistor Qs2 increases.

As described above, when a contact is made at the sensing unit SU, the amount of current i1 passing through the first output transistor Qs1 is reduced, and the amount of current i2 passing through the second output transistor Qs2 increases. Therefore, the amount of current ir=i1−i2 supplied to the amplifying unit 810 is significantly reduced. According to the variation amount of the current ir, the sensing voltage Vo outputted from the amplifier AP of the amplifying unit 810 increases as shown in (b′) of FIG. 9 compared to the sensing voltage outputted when a contact is not made at the sensing unit SU shown in (a′) of FIG. 9.

If the capacitance of a variable capacitor Cv increases by the second to fourth output transistors Qs2 to Qs4 when a contact is made at the sensing unit, ir−Δir=(i1−Δi)−(i2+Δi) because ir=i1−i2. (Herein, Δi=Δi1−Δi2).

That is, if a contact is made at the sensing unit SU, i1 is reduced by as much as Δi but i2 increases by as much as Δi. Therefore, the amount of current ir supplied to the amplifying unit 810 is reduced by as much as Δir.

Since −Δir=−2Δi in a view of the variation amount of the current only, the variation amount of the current supplied to the amplifying unit 810 when a contact is made at the sensing unit SU increases to about twice 115 compared to that when a contact is not made at the sensing unit SU. Therefore, the sensitivity of the sensing unit SU also improves.

According to the present invention, a plurality of sensing units are formed with a liquid crystal display when the liquid crystal display is manufactured without mounting an additional touch screen panel at a liquid crystal display. Therefore, the additional process for mounting the touch screen panel at the liquid crystal display is not necessary. Also, the problems such as increment of the thickness of the liquid crystal display and the deterioration of luminance can be eliminated.

Also, the sensitivity of the sensing units is improved by increasing a variation width of the output voltages generated when a contact is made at the sensing unit and when a contact is not made at the sensing unit through reducing a predetermined part of the current amount supplied to the amplifying unit.

While this invention has been described in connection with what is presently considered to be practical exemplary embodiments, it is to be understood that various modifications and equivalent arrangements will be apparent to those skilled in the art and may be made without, however, departing from the spirit and scope of the invention.

What is claimed is:

1. A liquid crystal display comprising:
a first display panel;
a second display panel separated from the first display panel to face the first display panel;
a liquid crystal layer placed between the first display panel and the second display panel;
a plurality of sensing data lines formed on the second display panel;
a plurality of variable capacitors connected to the sensing data lines and having capacitance that varies with pressure;
a plurality of reference capacitors connected to the sensing data lines; and
a plurality of sensing signal output units each connected to the sensing data lines for generating output signals on the basis of sensing data signals that flow through the sensing data lines,
wherein the sensing signal output units each change amounts of current based on the sensing data signals to reduce amounts of current corresponding to the output signals.

2. The liquid crystal display of claim 1, wherein each of the sensing signal output units comprises:
a first switching element connected to the sensing data line for changing an amount of current that flows through the first switching element according to variation of the capacitance of the variable capacitors;
a second switching element for receiving a second input signal and changing an operation state of the second switching element according to the second input signal;
a third switching element connected to the sensing data line and the second switching element for changing an amount of current that is output from the third switching element according to the variation of the capacitance of the variable capacitors and the operation state of the second switching element; and
a fourth switching element connected to the first switching element for changing an operation state of the fourth switching element to change an amount of current that flows through the fourth switching element according to the amount of current from the third switching element,
wherein the amount of current flowing through the first switching element and the amount of current flowing through the fourth switching element change to be opposite to each other, and wherein the output signals are determined based on the amount of current flowing through the first switching element and the amount of current flowing through the fourth switching element.

3. The liquid crystal display of claim 2, wherein, when the capacitance of the variable capacitors increases, the amount of current flowing through the first switching element decreases in proportion to the sensing data signal based on the capacitance, and the amount of current flowing through the fourth switching element decreases in inverse proportion to the sensing data signal based on the capacitance.

4. The liquid crystal display of claim 2, further comprising a plurality of reset signal input units each connected to the sensing data lines for receiving a reset voltage and providing the received reset voltage to the sensing data lines.

5. The liquid crystal display of claim 4, wherein each of the reset signal input units comprises a first reset switching element connected to a corresponding sensing data line for receiving a first reset voltage and applying the first reset voltage to the connected sensing data line according to a first reset control signal.

6. The liquid crystal display of claim 5, wherein each of the reset signal input units further comprises a second reset switching element connected to a corresponding sensing data line for receiving a second reset voltage and applying the second reset voltage to the connected sensing data line according to a second reset control signal.

7. The liquid crystal display of claim 6, wherein levels of the first reset voltage and the second reset voltage are opposite to each other.

8. The liquid crystal display of claim 5, wherein the first reset control signal has a turn-on voltage application time different from the second reset control signal.

9. The liquid crystal display of claim 2, further comprising a plurality of sensing signal processors for receiving the output signals and generating sensing signals based on the output signals.

19. The liquid crystal display of claim 9, wherein each of the sensing signal processors comprises an integrator for integrating the output signals to generate the sensing signals.

11. The liquid crystal display of claim 10, wherein the integrator comprises an amplifier and a capacitor.

12. A display device comprising:
a plurality of pixels;
a plurality of sensing data lines formed among the pixels;
a plurality of sensing units for changing magnitudes of sensing data signals to be output to the sensing data lines on the basis of capacitance that varies with an applied pressure; and
a plurality of sensing signal output units each connected to the sensing data lines for generating output signals on the basis of the sensing data signals that flow through the sensing data lines,
wherein the sensing signal output units each change amounts of current based on the sensing data signals to reduce amounts of current corresponding to the output signals.

13. A display device of claim 12, wherein each of the sensing signal output units comprises:
a first switching element connected to the sensing data line for changing an amount of current that flows through the first switching element according to operation variation of the sensing units;
a second switching element for receiving a second input signal and changing an operation state of the second switching element according to the second input signal;
a third switching element connected to the sensing data line and the second switching element for changing an amount of current that is output from the third switching element according to the variation of the capacitance of the variable capacitors and the operation state of the second switching element; and
a fourth switching element connected to the first switching element for changing an operation state of the fourth switching element to change an amount of current that flows through the fourth switching element according to the amount of current from the third switching element,
wherein the amount of current flowing through the first switching element and the amount of current flowing through the fourth switching element change to be opposite to each other, and wherein the output signals are determined based on the amount of current flowing through the first switching element and the amount of current flowing through the fourth switching element.

14. A display device of claim 13, wherein, when the capacitance of the variable capacitors increases, the amount of current flowing through the first switching element decreases in proportion to the sensing data signal based on the capacitance, and the amount of current flowing through the fourth switching element decreases in inverse proportion to the sensing data signal based on the capacitance.

15. The display device of claim 13, further comprising a plurality of reset signal input units each connected to the sensing data lines for receiving a reset voltage and providing the received reset voltage to the sensing data lines.

16. The display device of claim 15, wherein each of the reset signal input units comprises a first reset switching element connected to a corresponding sensing data line for receiving a first reset voltage and applying the first reset voltage to the connected sensing data line according to a first reset control signal.

17. The display device of claim 16, wherein each of the reset signal input units further comprises a second reset switching element connected to a corresponding sensing data line for receiving a second reset voltage and applying the second reset voltage to the connected sensing data line according to a second reset control signal.

18. The display device of claim 17, wherein levels of the first reset voltage and the second reset voltage are opposite to each other.

19. The display device of claim 16, wherein the first reset control signal has a turn-on voltage application time different from the second reset control signal.

20. The display device of claim 12, wherein each of the sensing units comprises a variable capacitor connected to the sensing data lines and having capacitance that varies with an applied pressure, and a reference capacitor connected to the sensing data lines and having a predetermined capacitance.

21. The display device of claim 12, further comprising a plurality of sensing signal processors for receiving the output signals and generating sensing signals based on the output signals.

22. The display device of claim 21, wherein each of the sensing signal processors comprises an integrator for integrating the output signals to generate the sensing signals.

23. The display device of claim 22, wherein the integrator comprises an amplifier and a capacitor.

24. A liquid crystal display having a touch screen, comprising
a plurality of periodically scanned pixels;
a matrix of variable capacitors formed among the pixels whose capacitance varies with pressure applied to the screen;
a plurality of sensing data lines connected to the capacitors;
means for periodically applying charging and reset voltages to the sensing data lines during a porch period of scanning;
a current integrator connected to each of the sensing data lines for generating an output current only during the time between the applying of the charging and reset voltages to the sensing data lines during the porch period; and
means for disabling wherein the sensing signal output units each change amounts of current based on the sensing data signals to reduce amounts of current corresponding to the output signals.
